(19) United States
(12) Patent Application Publication
(10) Pub. No.: US 2012/0190453 A1
(43) Pub. Date: Jul. 26, 2012

(54) SYSTEM AND METHOD FOR ONLINE-OFFLINE INTERACTIVE EXPERIENCE

(75) Inventors: Sarjoun Skaff, Pittsburgh, PA (US); David Palmer, Pittsburgh, PA (US); Marc Masnik, Portola Valley, CA (US); Enrique Alfaro, Mars, PA (US); Heer Gandhi, Pittsburgh, PA (US); James Kong, Pittsburgh, PA (US); Martin Hitch, San Francisco, CA (US)

(73) Assignee: BOSSA NOVA ROBOTICS IP, INC.

(21) Appl. No.: 13/357,589

(22) Filed: Jan. 24, 2012

Related U.S. Application Data
(60) Provisional application No. 61/435,794, filed on Jan. 25, 2011.

(51) Int. Cl. G06F 19/00; A63F 9/24

(52) U.S. Cl. 463/41; 463/40; 463/42

(57) ABSTRACT

A game system is provided that is configured for providing a dynamic online and offline interactive experience. The game system includes two portions; an interactive apparatus and an interactive application. The interactive apparatus may be, but is not limited to, toys such as robots, dolls, vehicles, play sets, and board games. The game system is configured such that a user's interactions with one of the interactive apparatus and the interactive application may affect the continuation of the user's interactive experience with the other.

### CROSS-REFERENCE TO RELATED APPLICATIONS

This application claims benefit of U.S. Provisional Patent Application Ser. No. 61/435,794, filed Jan. 25, 2011, which is herein incorporated by reference.

### BACKGROUND OF THE INVENTION

1. Field of the Invention

Embodiments described herein relate to interactive toys having corresponding interactive computer-based applications.

2. Description of the Related Art

Most if not all toys and games allow a user to enjoy an interactive experience. For example, physical toys and games, such as radio controlled cars, airplanes, helicopters, and the like, allow the user to control the speed and direction of the games. In another example, virtual games similarly allow the user to control the actions of virtual characters within the game. However, to date, the interactive experience of toys and games has been limited to either the “offline” experience with physical toys or the “online” experience with virtual games. The inventors have discovered that the user's interactive experience is synergistically enhanced by providing a toy or game that provides an offline experience aligned with an online experience.

### SUMMARY OF THE INVENTION

Embodiments of the present invention generally include a game system, associated methods and computer products. The game system is configured for providing a dynamic online and offline interactive experience. The game system includes two portions; an interactive apparatus and an interactive application. The interactive apparatus may be, but is not limited to, toys such as robots, dolls, and board games. The game system is configured such that a user's interactions with one of the interactive apparatus and the interactive application may affect the continuation of the user's interactive experience with the other.

In one embodiment, a game system is provided that includes an interactive apparatus having a communication system and an interactive application. The interactive application and interactive apparatus are independently operable to provide an offline and an online experience, wherein at least one of the interactive application and interactive apparatus is configured to modify its operation based on the experience of the other.

In another embodiment, a method of providing a dynamic online and offline interactive experience is provided that includes updating, at a first portion of an interactive game, data indicative of an interaction with a user during play with the first portion of the interactive game, the first portion of the interactive game being one of an interactive apparatus and an interactive application, and transferring the data indicative of the interaction with the user to a second portion of the interactive game, the second portion of the interactive game being the other of the interactive apparatus and the interactive application relative to the first portion.

In another embodiment, a method of providing a dynamic online and offline interactive experience includes generating, at an interactive apparatus, a first set of event records based on interactions with a user, providing the first set of event records to an interactive application, wherein the interactive application is configured to provide a corresponding interactive experience, receiving a second set of event records from the interactive application, wherein the second set of event records are generated based on the user's interactive experience with the interactive application, and modifying one or more apparatus behaviors of the interactive apparatus based on the received second set of event records.

In yet another embodiment, a computer program product is provided. The computer product includes a computer-readable storage medium having computer-readable program code embodied therewith. The computer-readable program code, when executed by a processor residing in an interactive apparatus, causes the interactive apparatus to perform a method that includes updating a first set of data based on interactions with a user, providing the first set of data to an interactive application, wherein the interactive application is configured to provide a corresponding interactive experience, receiving a second set of data from the interactive application, the second set of data generated based on an interactive experience with the interactive application, and modifying one or more behaviors characteristics of the interactive apparatus based on the received second set of data.

In another embodiment, a method of providing a dynamic online and offline interactive experience includes generating an association between a virtual avatar and an interactive apparatus, generating, at an interactive application, a first set of event records based on interactions of a user with the virtual avatar, providing the first set of event records to the interactive apparatus, wherein the interactive apparatus is configured to provide a corresponding interactive experience. The method further includes receiving a second set of event records from the interactive apparatus associated with the virtual avatar, wherein the second set of event records are generated based on the user's interactive experience with the interactive apparatus, and modifying one or more behaviors of the virtual avatar based on the received second set of event records.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically illustrates a game system configured to allow a dynamic online and offline interactive experience, according to one embodiment of the invention.

FIG. 2 is a schematic view of an interactive apparatus of the game system of FIG. 1, according to one embodiment of the invention.

FIG. 3 is a schematic view of an interactive application of the game system of FIG. 1 disposed on a computer system, according to one embodiment of the invention.

FIG. 4 illustrates one embodiment of the game system of FIG. 1 configured for providing a dynamic online and offline interactive experience.

FIG. 5 illustrates a method for providing a dynamic online and offline interactive experience, according to one embodiment of the invention.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

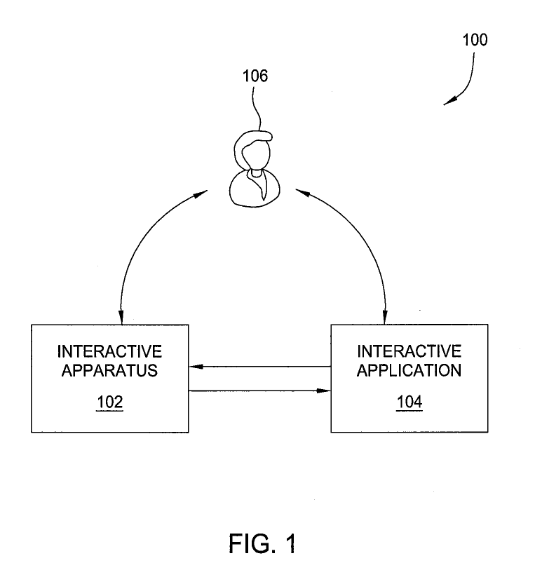

FIG. 1 illustrates one embodiment of a game system 100 configured for providing a dynamic online and offline interactive experience. The game system 100 includes two portions; an interactive apparatus 102 and an interactive application 104. A user 106 may interact (i.e., “play”) with the interactive apparatus 102 and the interactive application 104 in a variety of modes and manners described in detail later. In particular, at least one of the interactive apparatus 102 and the interactive application 104 is configured to adapt based on activities and/or the interactive experience of the user 106 with the other of the interactive apparatus 102 and the interactive application 104, or through interaction of other users via their interactive apparatuses and/or the interactive applications (i.e., other game systems) with at least one of the interactive apparatus 102 and the interactive application 104.

The interactive apparatus 102 is generally an object configured for entertaining.educating, or socializing with the user 106 through the user's interaction with the interactive apparatus 102. The interactive apparatus 102 may be, but is not limited to, toys such as robots, dolls, vehicles, play sets, and board games.

The interactive apparatus 102 is configured to modify its operation based on at least two types of interactions; the first being interactions between the user 106 and the interactive apparatus 102, and the second being interactions between the user 106 and the interactive application 104. Likewise, the interactive application 104 is configured to modify its operation based on at least two types of interactions; the first being interactions between the user 106 and the interactive application 104, and the second being interactions between the user 106 and the interactive apparatus 102. Accordingly, a user's interactions with one of the interactive apparatus 102 and the interactive application 104 may affect the continuation of the user's interactive experience with the other.

The interactive apparatus 102 includes a communication system that allows uploading and downloading of data and information to and from the interactive application 104. The data and information generated based on respective interactions with the user 106 may be utilized to modify the interactive experience between the user 106 and the game system 100, in either of the game's forms (i.e., the interactive apparatus 102 or interactive application 104.)

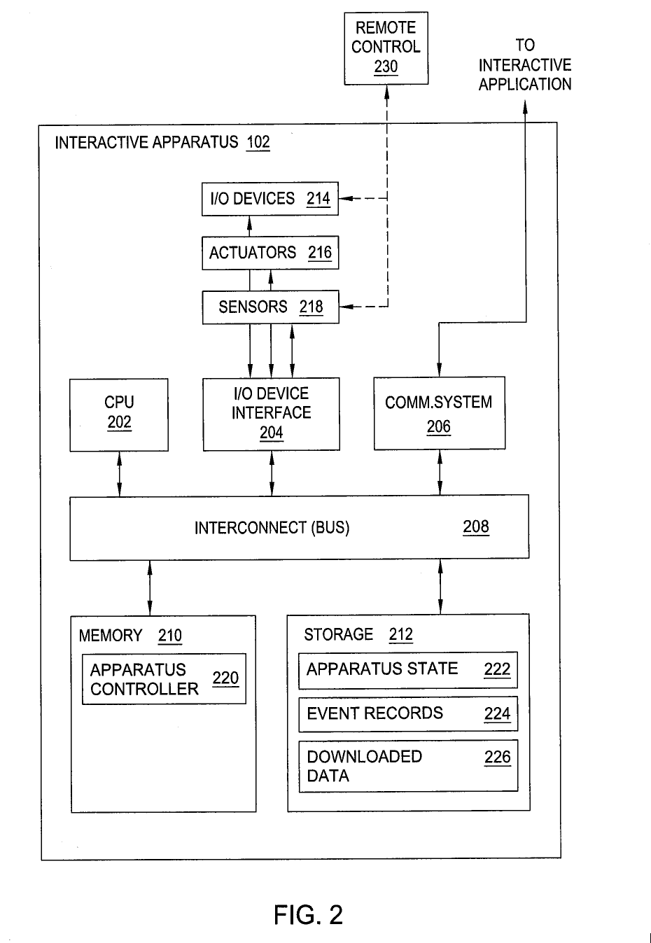

FIG. 2 is a more detailed view of the interactive apparatus 102 of FIG. 1, according to one embodiment of the invention. As shown, the interactive apparatus 102 includes, without limitation, a central processing unit (CPU) 202, an I/O device interface 204, a communication system 206, an interconnect (bus) 208, a memory 210, and storage 212.

The CPU 202 retrieves and executes programming instructions stored in the memory 210. Similarly, the CPU 202 stores and retrieves application data residing in the memory 210. The interconnect 208 is used to transmit programming instructions and application data between the CPU 202, I/O devices interface 214, storage 212, communication system 206, and memory 210. CPU 202 is included to be representative of a single CPU, multiple CPUs, a single CPU having multiple processing cores, and the like. In one embodiment, the CPU 202, memory 210, and storage 212 are configured to enable writing, modifying, erasing, and re-writing of programming instructions and computer code received from the interactive apparatus 102. The memory 210 is generally representative of a random access memory, but may be implemented in any variety and/or combination of suitable storage technologies as detailed below. Storage 212, such as a hard disk drive or flash memory storage drive, may store non-volatile data. It is contemplated that the memory 210 and storage 212 may take other forms.

In one embodiment, the communication system 206 is configured to allow for a bidirectional exchange of information data from the interactive apparatus 102 to the interactive application 104, and from the interactive application 104 to the interactive apparatus 102. Communication by the communication system 206 may take place in one or more modalities, including but not limited to, physical contact, wired connection, and wireless connection. Operation of the communication system 206 is described later in further detail.

The interactive apparatus 102 may also include a variety of I/O devices 214 connected via the I/O device interface 204 and configured to interact with the environment external to the interactive apparatus 102. Examples of I/O devices 214 include means for information output, such as audio visual devices (e.g., liquid crystal displays, display panels, light emitting diodes, audio speakers), and user input interfaces (e.g., buttons, wired or wireless controllers). Other devices of the interactive apparatus 102 include actuators 216 (e.g. motors), sensors 218 (e.g., proximity-sensors, light sensors, infrared sensors, gyroscopes, accelerometers), and peripheral devices (e.g., accessories). In one embodiment, the sensors 218 may include a wireless connectivity sensor, such as a radio frequency (RF) sensor, that enables peer-to-peer communication with other similar interactive apparatuses 102. The interactive apparatus 102 may further include circuitry and electronics configured to support the operation and to interpret data acquired from the I/O devices 214, actuators 216, and sensors 218.

The user 106 may interact with the interactive apparatus 102 through one or more of the I/O devices 214, sensors 218 and communication system 206. For example, the user 106 may interact with the interactive apparatus 102 through one or more of the I/O devices 214 in the form of switches, buttons and levers, cameras, microphones among other input devices. The I/O devices 214 may also be configured to communicate with a remote controller 230. The remote controller 230 may be a hand-held controller, a cell phone, smart phone, tablet computer or other mobile or non-mobile device. The communication between the remote controller 230 and the I/O devices 214 may be wired or wireless. In another example, the user 106 may interact with the interactive apparatus 102 through sensors 218 which generate a signal provided to the CPU 202 in response to the user's touch, sound or voice, and/or stimuli provided by interaction of the interactive apparatus 102 with other interactive apparatus and/or real world objects, such as sounds, force and obstacles, among others, including communication with other interactive apparatuses. In another example, the user 106 may interact with the interactive apparatus 102 through the communication system 206 as further described below.

The memory 210 includes an apparatus controller 220 configured to control operations of the interactive apparatus 102 and provide one or more modes of interaction with the user 106. The apparatus controller 220 expresses behavior and physical attributes of the interactive apparatus 102 via the I/O devices 214, actuators 216, and sensors 218. For example, the apparatus controller 220 may control movements of the interactive apparatus 102 using the actuators 216 to articulate arms or rotate wheels. In another example, the apparatus controller 220 may utilize the audio-visual I/O devices 214 to emit one or more audio-visual signals, such as lights and/or sounds.

The apparatus controller 220 maintains a logical state of the interactive apparatus 102, referred to herein as an apparatus state 222, within storage 212. The apparatus state 222 may represent one or more virtual attributes of the interactive apparatus 102. Examples of virtual attributes that comprise the apparatus state 222 include, but are not limited to, one or more of health, strength, stamina, money, points, experience, special power, and mood. In one implementation, the apparatus state 222 may be quantitatively expressed as one or more numerical values, Boolean values, and other known value systems, etc. The apparatus state 222 may further represent an “inventory” of qualities, attributes, and/or objects possessed by the interactive apparatus 102. Examples of objects within the inventory of the interactive apparatus 102 include, but are not limited to, awards, achievements, completed objectives, weapons, tools, money, magic and abilities. The apparatus state 222 may include one or more pre-defined behaviors for operating the interactive apparatus 102, such as pre-defined sequences of movements, lights, and/or sound.

In one embodiment, the apparatus controller 220 may utilize the apparatus state 222 to determine the operation of the interactive apparatus 102. Based on the apparatus state 222, the apparatus controller 220 may enable or disable behavior, routines, and/or capabilities of the interactive apparatus 102. Further, the apparatus controller 220 is configured to modify the apparatus state 222 based one or more interactions with the user 106 and based on information received from the interactive application 104, as described later.

The apparatus controller 220 generates information data responsive to the user 106 interacting with the interactive apparatus 102 using the I/O devices 214, actuators 216, and sensors 218. For example, the apparatus controller 220 may generate input data in response to a command from the user 106 via an I/O device 214, such as a remote controller, button press or voice command. In another example, the apparatus controller 220 may generate sensor data from the sensors 218 in response to stimulus external to the interactive apparatus 102, such as picking up, orientating, and/or squeezing the interactive apparatus 102. The generated data, sometimes referred to as “metrics”, may be stored as one or more event records 224 within storage 212. Each of the metrics may be recorded as separate events in the event records 224, or may be recorded in aggregate as a single general event.

The apparatus controller 220 is configured to modify the apparatus state 222 based on interactions with the user 106. As defined herein, the phrase “interactions with the user” is intended to include at least one or more of one or more commands and/or signals from the I/O device 214, engagement and/or communication with a second interactive apparatus, interaction of the interactive apparatus 102 with its surrounding environment as detected by the sensor 218, or a particular user input responsive to an output of the interactive apparatus 102. The apparatus controller 220 is configured to determine a change in the apparatus state 222 based on one or more interactions with the user 106. In one embodiment, the apparatus controller 220 may modify the apparatus state 222 within storage 212. The apparatus controller 220 may further store the change in the apparatus state 222 as one or more event records 224 within storage 212.

The event records 224 within storage 212 may contain metrics information about the apparatus' history of actuation, user input, information output, sensor data, apparatus state 222 (e.g., robot “health” and “status”), and information data received from one or more other interactive apparatuses (either controlled by the user or another person) which have communicated with the interactive apparatus 102. The interactive apparatus 102 may transmit the event records 224 containing information (e.g., about user input, information output, sensor data) apparatus state 222, or information data received from one or more other similar apparatuses to the interactive application 104 via the communication system 206, as described later.

In one example, the interactive apparatus 102 may be an interactive toy robot. The toy robot may prompt the user 106 to execute a selected “mission” stored in its memory having one or more gaming objectives. Alternatively, the user 106 may provide instructions to the toy robot while playing with the interactive apparatus 102 based on the imagination of the user 106. The user 106 provides input commands through I/O device 214 to activate actuators 216 and control the robot's actions. The toy robot also detects nearby objects and communicates with nearby toys using sensors 218, such as proximity sensors, infrared sensors and the like. The toy robot determines whether the inputted actions as instructed by the user 106 and the detected sensor data are sufficient to complete the gaming objective and earn “increased agility”. Responsive to determining that one or more gaming objectives have been completed, the toy robot may modify its own behavior to provide the user 106 with access to additional “missions” and light, sound, and motion behaviors. The toy robot generates log data based on the interactions with the user 106, including the button presses, sensor data, inventory changes and determined objective completion which is stored in the storage 212. The interactive apparatus 102 may optionally interact and communicate with one or more other interactive apparatuses that belong to the user 106 or others.

In another example, the interactive apparatus 102 may be an interactive doll. The user 106 plays with the interactive doll by directly manipulating the interactive doll and contacting the sensors 218 of the interactive doll. For instance, the interactive doll may activate audio clips of a hungry baby in response to having an apparatus state 222 indicating “hunger”. The user 106 may contact a sensor located near the mouth of the interactive doll with a bottle to signify “feeding” of the doll. The interactive doll detects the presence of the bottle and records the detection event in one or more event records 224. The interactive doll further updates the apparatus state 222 to reflect that the interactive doll has been “fed” and is no longer “hungry”. The interactive doll may respond to being “fed” with a sound signifying contentment. In response to the change in apparatus state 222, the interactive doll may cease behavior, such as audio clips and/or actuators movements, that denote hunger, and/or start behavior that indicates happiness by using the actuators 216 and/or I/O devices 214. The interactive doll records the change in apparatus state 222 in the event records 224.

Another other example of user 106 playing with the interactive doll in a manner that updates the apparatus state 222 may include teaching the doll a word or phrase, wherein the sensors of the doll detect the voice of the user and store the word or phrase in memory for later repetition by the doll, either in response to a prompt from the user, randomly, or in response to a rules-based algorithm executed by the CPU of the interactive apparatus 102. Another other example includes teaching the doll a physical action, such as walking or crawling, from inputs from the user via the I/O devices and/or sensors. For example, the sensors of the doll may detect the movement of the doll and/or parts of the doll (such as limbs) input from the user, and store the motion in memory for later repetition by the doll, either in response to a prompt from the user, randomly, or in response to a rules-based algorithm executed by the CPU of the interactive apparatus 102.

In yet another example, the interactive apparatus 102 may be an interactive board game. The interactive board game may be a word game, puzzle, strategy game, etc. The user 106 may play with the interactive board game either alone or with a number of other players, for example, in a turn-wise fashion. For example, the user 106 may interact with the game board by placement of the user's game piece in a particular location of the board which is detected by one or both of the sensor 218 and I/O devices 214. The interactive board game, in response to the position of the game piece, updates the appearance or status of the game board, updates the apparatus state 222, and generates one or more event records 224 representing such. For example, the game piece may land on a particular location of the board which gives the player an item such as money, power, magic, weapon and the like, and the apparatus state 222 would be updated to indicate the given item, and the event records 224 would be likewise updated.

The interactive apparatus 102 may also have one or more removable associated accessories 240. The accessory 240 may communicate with the communication system 206 interactive apparatus 102 and may transfer information relative to the operation and/or logical state of the accessory 240 to the interactive apparatus 102, which may store the information in the storage 212. The accessory logical state may represent one or more virtual attributes of the accessory 240. Examples of virtual attributes that comprise the accessory state include, but are not limited to, power of a weapon, inventory of food or water, status of a vehicle, event records and fuel among others.

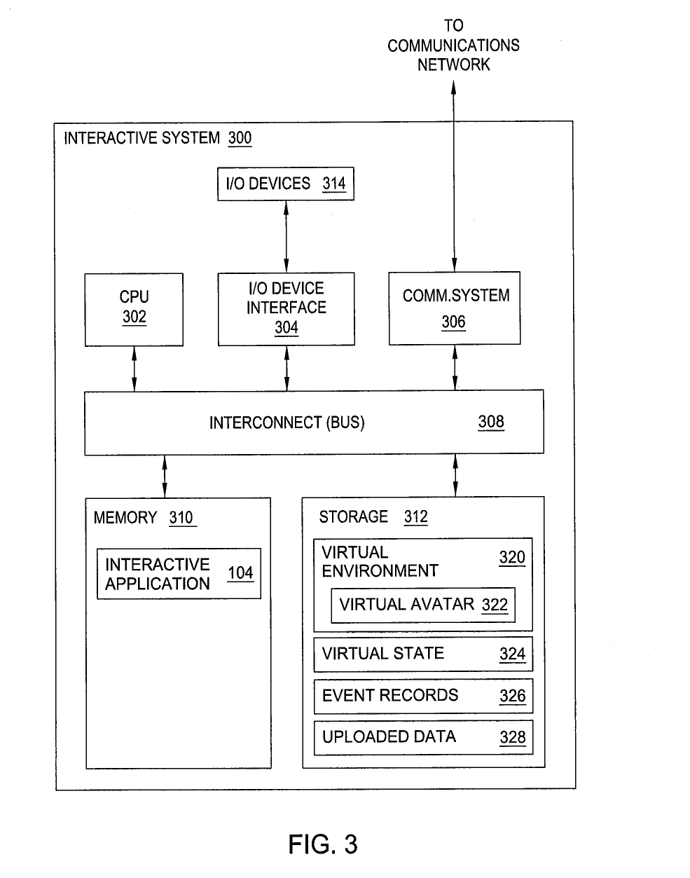

The interactive application 104 is generally a software application that may be interacted with or played by the user 106. In one embodiment, the interactive application 104 may be executed on an interactive system 300, as shown in FIG. 3. FIG. 3 is a schematic view illustrating one embodiment of the interactive system 300 in greater detail. As shown, interactive system 300 includes, without limitation, a central processing unit (CPU) 302, a communication system 306, an interconnect 308, a memory 310, and storage 312. The interactive system 300 may also include an I/O device interface 304 connecting I/O devices 314 (e.g., keyboard, display, touch screens, and mouse devices) to the interactive system 300. It is understood that a user 106 may utilize the I/O devices 314 to “interact” or “play” with the interactive application 104.

Like CPU 202 of FIG. 2, CPU 302 is configured to retrieve and execute programming instructions stored in the memory 310 and storage 312. Similarly, the CPU 302 is configured to store and retrieve application data residing in the memory 310 and storage 312. The interconnect 308 is configured to move data, such as programming instructions and application data, between the CPU 302, I/O devices interface 304, storage 312, communication interface 306, and memory 310. Like CPU 202, CPU 302 is included to be representative of a single CPU, multiple CPUs, a single CPU having multiple processing cores, and the like. Memory 310 is generally included to be representative of a random access memory. The communication system 306 is configured to transmit data to the interactive apparatus 102, as described later in detail. Although shown as a single unit, the storage 312 may be a combination of fixed and/or removable storage devices, such as fixed disc drives, floppy disc drives, tape drives, removable memory cards, optical storage, network attached storage (NAS), or a storage area-network (SAN).

The memory 310 stores the interactive application 104, and the storage 312 includes a virtual environment 320, virtual state 324, one or more event records 326, and uploaded data 328. The interactive application 104 provides a virtual interactive experience to the user 106 via the virtual environment 320 that may be interacted with by the user 106 over the interactive system 300. In one embodiment, the virtual environment 320 provides a gaming experience that includes one or more virtual avatars 322 that represent a character operable by the user 106. The virtual avatar 322 is the virtual identity of the interactive apparatus 102. The virtual avatar 322 may also include a virtual accessory corresponding to the accessory 240 utilized with the interactive apparatus 102.

The interactive application 104 is configured to maintain a virtual state 324 within storage 312 that represents a logical state of the virtual environment 320 and the virtual avatar 322 operated by the user 106. Similar to the apparatus state 222, the virtual state 324 may represent one or more virtual attributes of a virtual avatar 322, including, but not limited to, one or more of health, strength, stamina, money, points, experience, special power, and mood. The virtual state 324 may also represent one or more virtual attributes of the virtual accessory corresponding to the accessory 240 utilized with the interactive apparatus 102. Further, the virtual state 324 may represent an “inventory” of qualities, attributes, and/or objects possessed by the virtual avatar 322 within virtual environment 320, such as awards, achievements, completed objectives, weapons, magic, accessories, and abilities.

In one embodiment, the interactive application 104 may display the virtual environment 320 utilizing an I/O device 314, such as a display screen, based on the virtual state 324 of the virtual avatar 322. For example, the interactive application 104 may illustrate the virtual avatar 322 as having a full value for a health attribute. In one embodiment, the user 106 may input one or more commands via I/O devices 314 to instruct the virtual avatar 322 to perform an action within the virtual environment 320, including, but not limited to, walking, running, moving, talking, fighting, jumping, chatting, interaction with other virtual avatars of other games 100, etc. The interactive application 104 may permit the user 106 to have social interactions with one another via chat, voice, discussion forum, and other means of communications and interactions with third parties (e.g., other players, person, associations, clubs, etc.). The interactive application 104 modifies the virtual state 324 based on the one or more actions performed by the user 106 and/or experiences in the virtual environment 320, including interactions with other virtual avatars of other games 100. Each of the actions performed by the user 106 and any resultant changes in virtual state 324 may be recorded within one or more event records 326 stored within storage 312. The interactive application 104 may further be configured to determine whether one or more gaming objectives have been achieved by the user 106 responsive input actions performed by the user 106. Gaming objectives that have been achieved may also be recorded within event records 326. Generally, the interactive application 104 may record a history of user input, information output to the user 106, and all other user interactions with the interactive application 104 within one or more event records 326.

In one example, the interactive application 104 may be a computer video game application that provides the virtual environment 320 having the virtual avatar representing a robot character. The user 106 plays the computer video game application by guiding the virtual avatar through a number of missions, objectives, and battles with other players and non-player characters. The interaction with other players may include interaction with interactive applications 104 of other games 100 controlled by the other players. In response to events occurring in missions or other experiences in the virtual environment 320, such as achieving objectives, winning battles, gaining power, health, weapons, tools, food and the like, the interactive application 104 updates the virtual state 324 of the virtual avatar 322 accordingly so that these items/attributes may be later utilized when the user 106 again plays the computer game application. The interactive application 104 records change in the virtual state 324 within one or more of the event records 326. In one example, the virtual state 324 of the virtual avatar 322 is updated to reflect obtaining “increase of strength” by defeating an opponent in the virtual environment 320.

In another example, the interactive application 104 may be a computer game application that provides the virtual environment 320 having the virtual avatar that corresponds to a virtual doll character. The user 106 plays the computer game application by interacting with the virtual doll character and modifying one or more attributes of the virtual doll character. For instance, the user 106 may modify a hunger attribute of the virtual doll character by “feeding” the virtual doll character, modify the character's status by “changing the diaper” of the virtual doll character. The user 106 may also teach the virtual doll character a new motion, word, or phase, among others. The interactive application 104 records the interactions and resultant attributes changes the virtual doll character within one or more event records 326 and the changes in attributes are persisted throughout the user's interactions within the virtual environment 320.

In yet another example, the interactive application 104 may be a computer game application that provides a virtual environment 320 having a virtual gaming board. The user 106 plays with the virtual gaming board with other human and/or computer-controlled players. In one instance, the user 106 may interact with the virtual board game to unlock new abilities, objects and/or powers in the virtual gaming board or virtual state 324 of the user, for example, by defeating a number of human or computer-controlled opponents, landing on a predefined location of the virtual gaming board or other game occurrence. The interactive application 104 updates the virtual state 324 to reflect the possession and availability of the abilities, objects and/or powers of the user 106 and generates one or more event records 326 reflecting the updated state. The interactive application 104 may optionally interact and communicate with interactive applications 104 belonging to other games 100 controlled by other players. For example, the virtual state 324 to reflect obtaining money during an event occurring during play of the interactive application 104.

The interactive apparatus 102 and interactive application 104 are configured to communicate and exchange information data that may be used to modify the operations thereof. For example, the interactive application 104 may be configured to generate computer code, programming instructions, and other information data that is specifically targeted for one or more interactive apparatuses 102 owned by the user 106.

In one embodiment, the interactive application 104 may map a virtual avatar 322 to an interactive apparatus 102 of the user 106 to link the online experience of the virtual avatar 322 with the offline experience of the interactive apparatus 102. The interactive application 104 may be configured to create and store multiple such mappings for the user 106 that associate virtual avatars 322 to interactive apparatuses 102 owned by the user 106 in a one-to-one manner. The interactive application 104 and interactive apparatus 102 may be configured to exchange information data regarding linked virtual avatars 322 and interactive apparatuses 102 that may be used to modify the operations thereof. In one embodiment, the communication system 206 of the interactive apparatus 102 is configured to communicate with the interactive application 104 to provide apparatus state 222, event records 224, and other information data of the interactive apparatus 102. In one embodiment, the communication system 206 is configured to download data such as computer code and/or information data from the interactive application 104 and store the downloaded data 226 in storage 212. The computer code of the downloaded data 226 provides the interactive apparatus 102 with updated instructions and/or application logic for operating the interactive apparatus 102. The downloaded data 226 may also provides the interactive apparatus 102 with updated instructions and/or application logic for operating the accessory 240 which may be provided to the accessory 240 from interactive apparatus 102 when connected thereto. The apparatus controller 220 may execute the computer code of the downloaded data 226 to modify the apparatus state 222 and/or modify the behavior of the interactive apparatus 102 so as to affect at least one of actuation, sensing, user input, information output, and communication with other similar interactive apparatuses 102.

For example, the information data of the downloaded data 226 may include data indicating actions taken by the user 106 within the interactive application 104, herein after referred to as “virtual experience.” The apparatus controller 220 may modify the apparatus state 222 of the interactive apparatus 102 based on the virtual experience. For example, the apparatus controller 220 may modify the apparatus state 222 to match or synchronize the apparatus state 222 of the interactive apparatus 102 with the virtual state 324 of the interactive application 104.

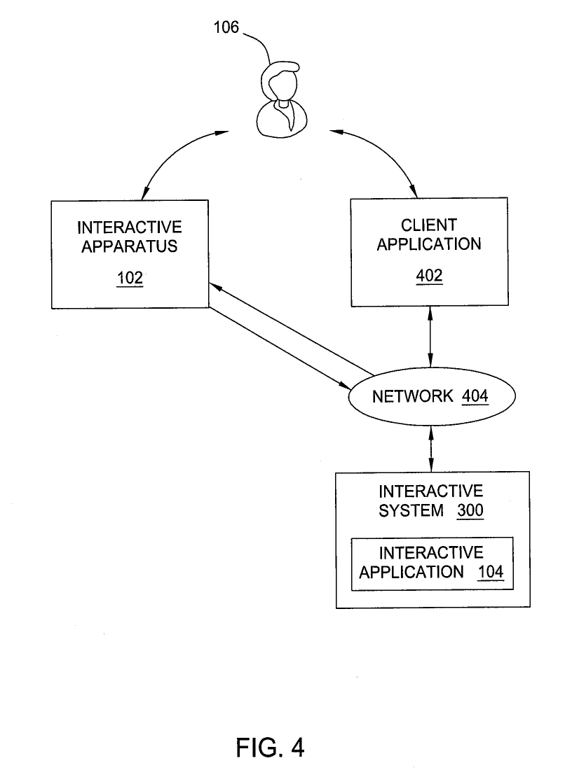

The communication system 206 is configured to communicatively connect the interactive apparatus 102 to the interactive application 104 using a variety of communications pathways, including wired and wireless pathways. In one implementation, the communication system 206 includes a networking interface, such as an Ethernet or wireless protocol, which connects the interactive apparatus 102 to the interactive application 104 via a communications network. In another implementation, the communication system 206 includes a peripheral interface, such as Universal Serial Bus (USB) interface, that connects the interactive apparatus 102 to a client system executing the interactive application 104. In yet another example, the communication system 206 may be a peripheral interface that connects to a client system configured to communicate with an interactive server executing the interactive application 104, as shown in FIG. 4.

Similarly, the interactive application 104 is configured to modify the virtual environment 320 based on uploaded data 328 received from the interactive apparatus 102. The uploaded data may include information data, such as metrics information about the interactive apparatus' history of actuation, user input, information output, sensor data, apparatus state 222 (e.g., robot “health” and “status”), accessory state, and information data received from one or more similar interactive apparatuses 102, as embodied by event records 224, and which represent the “offline” interactive experience of the user 106 with the interactive apparatus 102. The interactive application 104 may alter the virtual state 324 and other status and behavior of the virtual avatar 322 to incorporate information from the uploaded data 328.

In one embodiment, the interactive application 104 may interpret the uploaded data 328 from the interactive apparatus 102 to generate statistics about user interactions with the interactive apparatus 102 and the apparatus' history of apparatus state (e.g., “health” and status attributes), actuation, sensor information, information output, and communications with other similar interactive apparatuses. The generated statistics may be correlated with time. The interactive application 104 may further modify the interactive user experience with the interactive application 104 based on the statistics. The interactive application 104 may further utilize the statistics to generate computer code, programming instructions, and other information data specific to the interactive apparatus 102 related to these statistics.

The interactive application 104 may further be configured to generate computer code, programming instructions, and/or other information data whose content depends on both user interactions with the interactive apparatus 102 and direct user interactions with the interactive application 104.

As discussed above, the game system 100 allows for a bidirectional exchange of information data from the interactive apparatus 102 to the interactive application 104, and from the interactive application 104 to the interactive apparatus 102. In this manner, the interactive apparatus 102 may modify its operation based on information data indicative of interactions between the user 106 with the interactive application 104 downloaded to the interactive apparatus 102 from the interactive application 104, and conversely, the interactive application 104 may modify its operation based on information data indicative of interactions between the user 106 with the interactive apparatus 102 uploaded to the interactive application 104 from the interactive apparatus 102. Accordingly, the user's interactions with one of the interactive apparatus 102 and the interactive application 104 may affect the continuation of the user's interactive experience with the other.

Referring to the aforementioned example of the interactive apparatus 102 as an interactive toy robot, the user 106 operates the toy robot to complete one or more gaming objectives as directed by the toy robot. The completed objectives and other user interactions, including, for example, logged event data of button presses, sensor readings, and other data (e.g., goals, power, etc.), are recorded in one or more event records that may later provide data to the interactive application 104. In the corresponding example, the interactive application 104 is a computer video game application that provides a “virtual” environment having the virtual avatar representing the interactive apparatus 102 embodied as the interactive toy robot. The interactive application 104 updates the virtual environment, including the virtual avatar, based on the data received from the toy robot using the communication system 206. Specifically, the interactive application 104 updates the virtual avatar to reflect the “offline” experience having interacted with the toy robot and completed an “offline” objective. The “offline” experience may then be replayed using the virtual avatar 322 of the interactive application 104, or the interactive application 104 may be played with the virtual state 324 of the virtual avatar 322 updated by the data uploaded from the interactive apparatus 102. In the example above, during the offline experience with the interactive apparatus 102, the toy robot earned “increased agility”. Data uploaded to the interactive application 104 from the interactive apparatus 102 would then change the virtual state 324 of the virtual avatar 322 to provide the virtual avatar 322 with increased agility commensurate with what was earned during the offline experience.

Similarly, the user 106 may independently interact with the virtual avatar 322 of the interactive application 104 during an “online” experience. Data generated based on the game play of the user 106 with the interactive application 104, such as robotic motions, sounds, or mission objectives, may be downloaded to the interactive apparatus 102 to modify operation of the toy robot. In the example above, during the offline experience with the interactive application 104, the virtual avatar 322 obtained “increase strength”. Data downloaded from the interactive application 104 to the interactive apparatus 102 would then change the apparatus state 222 of the interactive apparatus 102 to provide the toy robot with increase strength commensurate with what was earned during the online experience.

Referring to the aforementioned example of the interactive apparatus 102 is an interactive doll, the user 106 plays with the interactive doll, for example but not limited to, the examples provided above which causes the apparatus state 222 to be updated. The interactive doll records the change in apparatus state 222 in the event records 224. When the interactive apparatus 102 and interactive application 104 are linked via the communication system 206, the event records 224 are uploaded to the interactive application 104. In the example above, during the offline experience with the interactive apparatus 102, the toy doll was taught a new motion, for example, how to crawl. Data uploaded to the interactive application 104 from the interactive apparatus 102 would then change the virtual state 324 of the virtual avatar 322 to provide the virtual avatar 322 with the ability to perform the new motion commensurate with what was learned during the offline experience, i.e., the virtual avatar 322 would now know how to crawl.

Similarly, the user 106 may independently interact with the virtual doll character form of the virtual avatar 322 in the interactive application 104 during an “online” experience. Data generated based on the game play of the user 106 with the interactive application 104 such as described above may be downloaded to the interactive apparatus 102 to modify operation of the toy doll. In the example above, during the offline experience with the interactive application 104, hunger of the virtual avatar 322 was satisfied by feeding. Data downloaded from the interactive application 104 to the interactive apparatus 102 would then change the apparatus state 222 of the interactive apparatus 102 so that the toy doll would not indicate to the user that the toy doll was hungry for a time period commensurate with the amount the virtual doll character was feed during the online experience.

In the example where the interactive apparatus 102 is an interactive board game, the interactive board game updates the apparatus state 222 to reflect that the actions taken by user 106 during play and records changes to the apparatus state 222 in one or more event records 224 representing such. The event records 224 may be uploaded to the interactive application 104 when connected with the interactive apparatus 102. In this example, the interactive application 104 may be a computer video game application that provides a virtual game board corresponding to the physical game board of the interactive apparatus 102. The interactive application 104 receives the event records 224 and updates the virtual game board to reflect that the actions of the user 106 with the physical game board. Further, the interactive application 104 may notify other players communicating with the interactive application 104 in a current game session of changes performed on the physical game board. As such, embodiments advantageously permit a user experience with a physical game board that may be coordinated with a virtual game board accessible to other players over a distributed data network, such as the Internet. In the example above, during the offline experience with the interactive apparatus 102, “magic” was obtained by landing on a position of the board game. Data uploaded to the interactive application 104 from the interactive apparatus 102 would then change the virtual state 324 of the interactive application 104 with magic corresponding to with that which was gained during the offline experience. The user 106 would then be able to use the magic obtained in the offline experience during play with the interactive application 104.

Similarly, the interactive apparatus 102 receives information data from the virtual board game that reflects the user's interactions with the virtual board game. For instance, the interactive board game may modify its apparatus state 222 to make available new game provided within the received information data. In another instance, the interactive board game may update its apparatus state 222 to modify rules of the interactive board game according to unlocked variations provided in the received information data.

Accordingly, the user 106 may have an “offline” interactive experience with the interactive apparatus 102 that is coordinated with an “online” interactive experience with the interactive application 104.

Further, the interactive application 104 may be configured to permit the “offline” experience by the user 106 to be replayed within the virtual environment 320. The interactive application 104 may utilize event records 224, including metrics information about the apparatus' history of actuation, user input, information output, sensor data, apparatus state 222 (e.g., robot “health” and “status”), and information data received from one or more similar interactive apparatuses to depict a graphical representation of the user interactions with the interactive apparatus 102. The graphical illustration may include computer-generated graphics and sound effects that dramatically illustrate the “offline” experience of the interactive apparatus 102 in the virtual environment 320 of the interactive application 104. In one embodiment, the interactive application 104 may be used to modify events occurring during the “offline” experience while replaying. The modification to the events may be saved and communicated back to the interactive apparatus 102, which in turn, change one or more operating characteristics of the interactive apparatus 102.

The interactive system 300 illustrated in FIG. 3 is merely one example of one computing system on which the interactive application 104 may be played. It is appreciated that the interactive system 300 may be implemented as a variety of systems, platforms, and architectures, including, but not limited to, computer systems, server systems, gaming consoles, mobile devices, cell phones, tablets, virtualized infrastructures, and cloud computing platforms. For example, the interactive application 104 may be a video game hosted on a gaming console or personal computer. Further, while FIG. 3 illustrates a single system model, other models are contemplated such as a client-server model, as illustrated in FIG. 4 or a peer-to-peer model. In the embodiment shown in FIG. 4, interactive application 104 may be a server-based video game application executing on a remote server (e.g., interactive system 300) accessible via a network 404. The user 106 may connect to the interactive application 104 via a client application 402 running on a local client system (not shown). In one example, the interactive application 104 may be web-based gaming application that the user 106 accesses via the client application 402, such as a web browser application. In the example shown in FIG. 4, the interactive apparatus 102 may independently connect to interactive application 104 via network 404 utilizing communications system 206 to exchange information data, as described above.

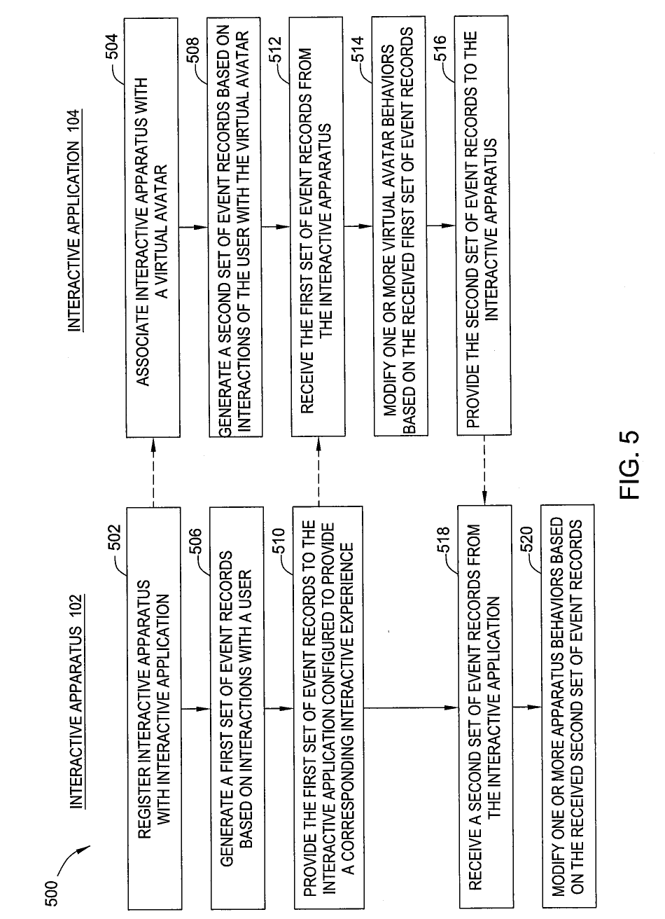

FIG. 5 illustrates a method for providing a dynamic online and offline interactive experience. As shown, the method 500 begins at step 502, wherein the interactive apparatus 102 communicates with the interactive application 104 to request registration of the interactive apparatus 102 of the user 106. At step 504, responsive to the registration request, the interactive application 104 associates the interactive apparatus 102 with a virtual avatar (e.g., virtual avatar 322) of the interactive application 104.

The method 500 proceeds to step 506, wherein the interactive apparatus 102 generates a first set of event records based on interactions with the user 106. Similarly, at step 508, the interactive application 104 generates a second set of event records based on interactions with user 106. In the method 500 described herein, “a set of event records” may refer to any grouping (including singletons) of one or more event records (e.g., event records 224 or 326) generated by at least one of the interactive apparatus 102 and interactive application 104 based on interactions with the user 106. The set of event records may be stored as a discrete package of information data or, alternatively, may be stored as a sequential flow of information data, and implemented in any suitable data format for storing information, including structured documents such as Extensible Markup Language (XML). Further, the terms “first set” and “second set” are used in description of the method 500 for sake of discussion and are not intended to limit the scope of the present invention with regards to the temporal order for generating, providing, and/or receiving event records. For example, it is appreciated that the interactive application 104 may generate a first set of event records based on interactions with a user, and may exchange the first set for a second set of event records generated by the interactive apparatus 102.

At step 510, the interactive apparatus 102 provides the first set of event records to the interactive application 104 that is configured to provide a corresponding interactive experience. For example, interactive apparatus 102 provides the first set of event records to the interactive application 104 having a virtual avatar associated with the interactive apparatus 102, as registered in step 502 above. At step 512, the interactive application 104 receives the first set of event records from the interactive apparatus 102. At step 514, the interactive application 104 modifies operations of the interactive application, such as one or more behaviors of the associated virtual avatar, based on the received first set of event records.

At step 516, the interactive application provides the generated second set of event records to the interactive apparatus. At step 518, the interactive apparatus 102 receives the second set of event records from the interactive application 104. As described above, the second set of event records are generated based on the user's interactive experience with the interactive application 104, for example, such as interactions with the associated virtual avatar. At step 520, the interactive apparatus 102 modifies one or more apparatus behaviors based on the received second set of event records.

While the method 500 for providing a dynamic online and offline interactive experience has been described as an asynchronous exchange of information data (e.g., event records) during a pre-determined occasion (e.g., when a robot is plugged in and connected to an online game), it is appreciated that synchronous forms of communication between the interactive apparatus 102 and the interactive application 104 are well within the scope of the present invention. For example, the interactive apparatus 102 may be continuously in communication with the interactive application 104 and may communicate event records and/or other information data to the interactive application 104 as soon as, or immediately after, the event records 224 and/or other information data are generated. Similarly, the interactive application 104 may transmit one or more event records 326 to the interactive apparatus 102 as soon as, or immediately after, the event records 326 are generated by the interactive application 104.

While embodiments of the present disclosure have been described in terms of a game system, it is appreciated that other forms, types, and classes of interactions, including but not limited to educational, therapeutic, and/or social interactions between users and the interactive apparatus and application are well within the scope of the present invention. As one skilled in the art will appreciate, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be used. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), Ferroelectric RAM (FRAM), phase-change memory (PCM), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, Ruby, Python, or the like and conventional procedural programming languages, such as the “C” programming language or similar programming languages, or in low-level computer language or assembly code. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a wide area network (WAN), or a wireless wire area network (WWAN), such as a 3G or LTE wireless network, or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the foregoing is directed to embodiments of the present invention, other and further embodiments of the invention may be devised without departing from the basic scope thereof, and the scope thereof is determined by the claims that follow.

What is claimed is:

1. A game system comprising:
an interactive apparatus having a communication system; and
an interactive application, the interactive application and the interactive apparatus are independently operable to provide an offline and an online experience, wherein at least one of the interactive application and interactive apparatus is configured modify its operation based on the experience of the other.

2. The game system of claim 1, wherein the interactive apparatus is a toy.

3. The game system of claim 2, wherein the toy is a robot, a doll, a vehicle, play set, or a board game.

4. The game system of claim 1, wherein the interactive apparatus comprises:
a memory configured to store one or more event records representing user interactions with the interactive apparatus.

5. The game system of claim 1, wherein the communication system of the interactive apparatus is configured to transfer one or more event records representing user interactions with the interactive apparatus to the interactive application.

6. The game system of claim 5, wherein the interactive application is configured to modify operations in response to data received from the interactive apparatus.

7. The game system of claim 1, wherein the interactive application is configured to provide one or more event records to the interactive apparatus.

8. The game system of claim 7, wherein the interactive apparatus is configured to modify its operation in response to the one or more event records provided by the interactive application.

9. The game system of claim 1, wherein the interactive application is configured to generate a graphical depiction of an offline experience provided by the interactive apparatus.

10. The game system of claim 1, wherein the interactive application is executing on a computing platform selected from the group consisting of a game console, a mobile device, a cell phone, a smart phone, a tablet, a personal computer, a server and cloud platform.

11. The game system of claim 1 further comprising:
an accessory removably attachable to the interactive apparatus, wherein the accessory is configured to modify its operation based on the experience of the interactive application.

12. The game system of claim 1 further comprising:
an accessory removably attachable to the interactive apparatus, wherein the interactive application is configured to modify its operation based on the experience of the interactive application.

13. A method of providing a dynamic online and offline interactive experience, the method comprising:
updating, at a first portion of an interactive game, data indicative of an interaction with a user during play with the first portion of the interactive game, the first portion of the interactive game being one of an interactive apparatus and an interactive application; and
transferring the data indicative of the interaction with the user to a second portion of the interactive game, the second portion of the interactive game being the other of the interactive apparatus and the interactive application relative to the first portion.

14. The method of claim 13 further comprising:
replaying the interaction of the user with the first portion of the interactive game in a virtual environment based on the transferred data.

15. The method of claim 13 further comprising:
replaying the interaction of the user during play with the first portion of the interactive game in a virtual environment based on the transferred data; and
modifying a sequence of events in the virtual environment during replay of the interaction of the user with the first portion of the interactive game.

16. The method of claim 13, wherein transferring further comprises:
bidirectionally communicating information between the interactive apparatus and the interactive application through a communication system of the interactive apparatus.

17. The method of claim 13, wherein play with the first portion of the interactive game comprises:
interacting with the interactive application on a computing platform selected from the group consisting of a game console, a mobile device, a cell phone, a smart phone, a tablet, a personal computer, a server and cloud platform.

18. The method of claim 17, wherein interacting with the interactive application comprises:
interacting with other players online.

19. The method of claim 13, wherein updating the data indicative of the interaction with the user during play with the first portion of the interactive game comprises:
updating the data in response to signals from at least one of a sensor or actuator of a first toy.

20. The method of claim 19, wherein updating the data indicative of the interaction with the user during play with the first portion of the interactive game comprises:
updating the data in response to the interaction with a second toy.

21. The method of claim 13, wherein the data indicative of the interaction with the user further comprises:
at least one of data indicative of an interaction with an accessory coupled to the interactive apparatus or data indicative of an interaction with an avatar of an accessory coupled to an avatar of the interactive apparatus in the interactive application.

22. A method of providing a dynamic online and offline interactive experience, the method comprising:
generating, at an interactive apparatus, a first set of event records based on interactions with a user;
providing the first set of event records to an interactive application, wherein the interactive application is configured to provide a corresponding interactive experience;
receiving a second set of event records from the interactive application, wherein the second set of event records are generated based on the user's interactive experience with the interactive application; and
modifying one or more apparatus behaviors of the interactive apparatus based on the received second set of event records.

23. A computer program product, comprising a computer-readable storage medium having computer-readable program code embodied therewith, the computer-readable program code, when executed by a processor residing in an interactive apparatus, causes the interactive apparatus to perform a method comprising:
updating a first set of data based on interactions with a user;
providing the first set of data to an interactive application, wherein the interactive application is configured to provide a corresponding interactive experience;
receiving a second set of data from the interactive application, the second set of data generated based on an interactive experience with the interactive application; and
modifying one or more behaviors characteristics of the interactive apparatus based on the received second set of data.

24. A method of providing a dynamic online and offline interactive experience, the method comprising:
generating an association between a virtual avatar and an interactive apparatus;
generating, at an interactive application, a first set of event records based on interactions of a user with the virtual avatar;
providing the first set of event records to the interactive apparatus, wherein the interactive apparatus is configured to provide a corresponding interactive experience;
receiving a second set of event records from the interactive apparatus associated with the virtual avatar, wherein the second set of event records are generated based on the user's interactive experience with the interactive apparatus; and
modifying one or more behaviors of the virtual avatar based on the received second set of event records.
